(19) United States
(12) Patent Application Publication
(10) Pub. No.: US 2005/0272629 A1
(43) Pub. Date: Dec. 8, 2005

(54) Detergent particle

(76) Inventors: Motomitsu Hasumi, Wakayama-shi (JP); Toshiki Nishi, Wakayama-shi (JP); Teruo Kubota, Wakayama-shi (JP); Shu Yamaguchi, Wakayama-shi (JP); Hideichi Nitta, Wakayama-shi (JP); Hiroyuki Yamashita, Wakayama-shi (JP)

Correspondence Address: BIRCH STEWART KOLASCH & BIRCH, PO BOX 747, FALLS CHURCH, VA, 22040-0747, US

(21) Appl. No.: 10/524,029

(22) PCT Filed: Aug. 13, 2003
(86) PCT No.: PCT/JP03/10279

§ 371 Date: Feb. 9, 2005

(30) Foreign Application Priority Data
Aug. 30, 2002 (JP) 2002-256222
Dec. 26, 2002 (JP) 2002-378465

(51) Int. Cl. C11D 17/00

(52) U.S. Cl. 510/447

(57) ABSTRACT

A detergent particle comprising a base detergent particle, a base layer comprising a fine powder, prepared by treating a surface of the base detergent particle with a fine powder dispersion, in which a fine powder is dispersed in a binder, wherein the base layer is formed on the surface of the base detergent particle, and a surface coating comprising a surface modifier, which is formed on the base layer; a process for preparing a detergent particle, comprising the steps of treating a surface of a base detergent particle with a fine powder dispersion in which the fine powder is dispersed in a binder as a dispersion medium to form a base layer on the surface of the base detergent particle; and surface-coating the base layer with a surface modifier; and a fine powder dispersion for forming a base layer comprising a binder and a fine powder, wherein the fine powder is dispersed in the binder. The detergent composition comprising the detergent particle of the present invention can be used as laundry detergents, laundry bleaching agents, cleaning agents for hard surfaces such as detergents for automatic dishwashers, pipe cleaners, and the like.

### TECHNICAL FIELD

The present invention relates to a detergent particle, a process for preparing the detergent particle, and a fine powder dispersion for forming a base layer used in the preparation of the detergent particle. More specifically, the present invention relates to a detergent particle comprising a base layer, prepared by treating the surface of a base detergent particle with a fine powder dispersion, in which a fine powder is dispersed in a binder as a dispersion medium, wherein the base layer is formed on the surface of the base detergent particle, and a surface coating comprising a surface modifier, which is formed on the base layer; a process for preparing the detergent particle; and a fine powder dispersion for forming a base layer used in the preparation of the detergent particle.

### BACKGROUND ART

In a powder detergent, detergent particles may bond to each other during long-term storage, thereby causing a caking phenomenon in which the detergent particles are in a solidified state. The leading causes are storage (maintenance) temperature and absorption of an external component, such as moisture or carbon dioxide gas, during storage of the detergent particles. When moisture is absorbed, moisture causes liquid cross-linking between the detergent particles or partial dissolution of the surface components of the detergent particle, whereby a portion having an adhesive property is formed on the surface of the detergent particle, thereby causing a caking phenomenon. Also, when carbon dioxide gas is absorbed, carbon dioxide reacts with an alkali component and moisture, so that an acicular crystal of sodium hydrogencarbonate, sodium sesquicarbonate or the like is produced in a burr-like form on the surface of the detergent particle. This acicular crystal on the surface of one detergent particle intertwines with a burr-like acicular crystal on the surface of another neighboring detergent particle, thereby causing a caking phenomenon.

The caking phenomenon generated due to the above causes gives rise to problems of drastically impairing not only the external appearance but also the convenience in use of the detergent in that accurate dosing cannot be made.

In order to solve the above problems, various studies have been made so far. For instance, Technical Publication Tokkyocho Koho 10(1998)-25[7159]: Shuchi and Kanyo Gijutsu Shu (Clothes Powder Detergent: Japanese Patent Office, published on Mar. 26, 1998) discloses a method comprising coating a detergent particle with a water-insoluble inorganic powder such as calcium stearate, magnesium carbonate, aluminosilicate or the like. However, there are some problems in any of the known coating methods in that the adhesive property between the surface of the detergent particle and the surface modifier is not sufficient, and that the surface modifier is stripped off due to stress applied to the detergent particle during conveying during the manufacturing process or the like, so that sufficient benefits cannot be obtained for practical purposes. In addition, Japanese Patent No. 2965905 discloses a method comprising mixing a granular detergent composition with a liquid binder, and thereafter coating the resulting mixture with an X-type zeolite, thereby giving the detergent particle free flowability. However, there are some problems in this method. Since zeolite X, which is the coating powder, is stripped off due to stress applied to the detergent particle during conveying in its manufacturing process as described above, sufficient benefits cannot be obtained. Moreover, the dissolubility is lowered if the amount of the binder is large.

As a result of intensive studies in order to solve the above problems, it has been found for the first time that the adhesive property of the surface modifier is surprisingly improved by treating the surface of a base detergent particle with a dispersion prepared by suspending a fine powder in a binder to form a base layer, thereby creating fine rugged surfaces on the particle surface, and enhancing the adhesive effect of the binder, which result in dramatic improvement in anti-caking property without causing inconveniences such as a decrease in dissolubility.

Accordingly, an object of the present invention is to provide a detergent particle having remarkably an improved anti-caking property, and excellent dissolubility and adhesive property of the surface modifier, a process for preparing the detergent particle, and a fine powder dispersion for forming a base layer used in the detergent particle.

### DISCLOSURE OF INVENTION

Accordingly, there are provided:
[1] a detergent particle comprising:
   a base detergent particle,
   a base layer comprising a fine powder for forming a base layer, prepared by treating a surface of the base detergent particle with a fine powder dispersion, wherein a fine powder is dispersed in a binder, wherein the base layer is formed on a surface of the base detergent particle, and
   a surface coating comprising a surface modifier, which is formed on the base layer;
[2] a process for preparing a detergent particle, comprising the steps of:
   treating a surface of a base detergent particle with a fine powder dispersion, thereby forming a base layer on the surface of the detergent particle, wherein the fine powder dispersion comprises a fine powder dispersed in a binder, and
   surface-coating the base layer with a surface modifier;
[3] a fine powder dispersion for forming a base layer comprising a binder and a fine powder, wherein the fine powder is dispersed in the binder; and
[4] a detergent particle comprising:
a) a base detergent particle,
b) a base layer formed on the surface of the base detergent particle, wherein the base layer comprises a fine powder and a binder, and
c) a surface modifier coated on the base layer.

### BRIEF DESCRIPTION OF THE DRAWINGS

FIG. 1 shows an SEM image (magnification: 1000) of a split cross section of a final detergent composition.

### BEST MODE FOR CARRYING OUT THE INVENTION

As mentioned above, one of the great features of the present invention resides in that the detergent particle comprises a base detergent particle, a base layer, prepared by treating the surface of the base detergent particle with a fine powder dispersion, in which a fine powder is dispersed in a binder, wherein the base layer is formed on the surface of the base detergent particle, and a surface coating comprising a surface modifier, which is formed on the base layer. In particular, fine rugged surfaces which are formed by the base layer formed on the surface of the base detergent particle by treating the surface of the base detergent particle with the fine powder dispersion exhibit an effect in that the stripping property of the surface modifier, added in the subsequent steps, is suppressed, thereby resulting in the improvement in the adhesive property. In other words, when stress is applied to a detergent particle during production, contrary to a case where a detergent particle has a smooth surface which undesirably causes slippage or chipping of its surface modifier layer, in a case where there exists a base layer as in the present invention, the slippage of the surface modifier can be suppressed because of the fine rugged surfaces acting as structural support. Here, the term “adhesive property” is an expression showing a balance between the ease of adhesion and ease of stripping the surface modifier.

The treatment as mentioned above can be carried out by using a mixer. Specifically, the treatment can be carried out by charging a mixer with a binder and a fine powder dispersion for forming a base layer, and operating the mixer. In the case where mixing is carried out by a batch process, the mixers include, for instance, (1) a mixer in which blending of powders is carried out with a mixing vessel having an agitating shaft in the inner portion thereof and agitating impellers attached to the agitating shaft, such as a Henschel Mixer (manufactured by Mitsui Miike Machinery Co., Ltd.), a High-Speed Mixer (Fukae Powtec Corp.), a Vertical Granulator (manufactured by Powrex Corp.), a Lödige Mixer (manufactured by Matsuzaka Giken Co., Ltd.), a PLOUGH SHARE Mixer (manufactured by PACIFIC MACHINERY & ENGINEERING Co., LTD.), and mixers disclosed in Japanese Patent Laid-Open No. Hei 10-296065; (2) a mixer in which blending is carried out with a non-rotatable vessel which is cylindrical or semi-cylindrical, in which spiral ribbon impellers are rotated therein, such as a Ribbon Mixer (manufactured by Nichiwa Kikai Kogyo K.K.) and a Batch Kneader (manufactured by Satake Kagaku Kikai Kogyo K.K.); (3) a mixer in which blending is carried out by revolving a screw along a conical vessel, with auto-rotation centering about a rotating shaft arranged parallel to the vessel wall, such as a Nauta Mixer (manufactured by Hosokawa Micron Corp.), and Ribocone (manufactured by OKAWARA MFG. CO., LTD.).

In addition, continuous-type mixers of the above-mentioned mixers may be used. Also, as the continuous-type mixers other than those mentioned above, the following devices (1) to (3) can be used, provided that mixing conditions such as rotational speed of the main shaft must be selected to an extent that the base detergent particle is not disintegrated. In the case where mixing is carried out by a continuous process, the mixers include (1) a continuous mixer comprising a vertical cylinder having a powder supply opening and a main shaft having a blending blade, the main shaft being supported by an upper bearing and the vertical cylinder having a free discharging side, to carry out blending of the components, such as Flexo Mix (manufactured by Powrex Corp.); (2) a continuous mixer comprising a disc plate with agitating pins, to which the starting materials are supplied on the upper portion of the disc plate, the disc plate being rotated, to thereby carry out blending of the components with a shear force; and (3) a continuous mixer comprising a horizontal mixer having an agitating shaft arranged in the inner portion of the mixer and agitating impellers arranged on the shaft, to carry out blending of the components, such as Turbulizer (manufactured by Hosokawa Micron Corporation).

The above-mentioned treatment temperature is preferably from 40 to 100° C.; its lower limit is more preferably 50° C., and its upper limit is more preferably 90° C. The treatment time may be preferably from 1 to 10 minutes or so. Also, a process for adding a fine powder dispersion for forming a base layer to the mixer is not particularly limited. It is preferable that the dispersion is added by spraying.

By the treatment method, a base layer comprising a fine powder is formed on the surface of the base detergent particle. It is preferable that the base layer is uniformly formed on the entire surface of the base detergent particle. Since there is a mutual suppressive stripping action by the interference of the surface modifiers which are coated in the subsequent step, it is not necessary that the entire surface of the base detergent particle be treated by a surface modifier, and similar effects can be obtained by partly forming a base layer, preferably forming a base layer on 30% or more of the surface of the base detergent particle. The formation of the base layer of this base detergent particle can be confirmed by slicing a detergent particle, and observing the enlarged particle near the surface with an electronic microscope or the like.

Next, the resulting base detergent particle having the base layer is subjected to surface coating with a surface modifier, whereby the detergent particle of the present invention can be prepared.

The detergent particle of the present invention will be explained in detail hereinbelow.

The base detergent particle usable in the present invention refers to a particle which is ordinarily used in powder detergents. The base detergent particle includes, for instance, a particle before subjected to treatment with a surface modifier, comprising a surfactant, an alkalizing agent and optionally other detergent components. The base detergent particle may be those prepared by spray-drying the above-mentioned components in a slurry state, and subjecting the spray-dried particle to agitation and granulation, tumbling granulation, or kneading and mixing granulation. A base detergent particle comprising a particle obtained by contacting a spray-dried particle substantially containing no surfactants with a mixed solution comprising one or more surfactants to support the mixed surfactant solution, such as a spray-dried particle comprising one or more water-soluble components selected from a water-soluble polymer and a water-soluble salt, especially a spray-dried particle comprising both the water-soluble polymer and the water-soluble salt, is preferable because the base detergent particle has excellent dissolubility and the effects of the present invention become remarkable.

The surfactant includes anionic surfactants, nonionic surfactants, amphoteric surfactants and cationic surfactants, which may be optionally formulated in the base detergent particle. The anionic surfactant includes sulfate ester of higher alcohols, sulfate ester of ethoxylated products of higher alcohols, alkylbenzenesulfonates, paraffinic sulfonates, α-olefinsulfonates, salts of α-sulfofatty acids or alkyl esters thereof, salts of fatty acids, and the like. Especially, preferable are linear alkylbenzenesulfonates having 10 to 18 carbon atoms, more preferably 12 to 14 carbon atoms, and salts of alkyl esters of α-sulfofatty acids having 10 to 20 carbon atoms.

The nonionic surfactant includes ethylene oxide (hereinafter referred to as “EO”) adducts or EO/propylene oxide (hereinafter referred to as “PO”) adducts of higher alcohols, fatty acid alkanolamides, alkyl polyglycosides and the like. Especially, EO (1 to 10 mol) adducts of alcohols having 10 to 16 carbon atoms are preferable, from the viewpoints of removal of sebum dirt stains, hard water resistance and biodegradation, and from the viewpoint of its compatibility with linear alkylbenzenesulfonate.

The amphoteric surfactant includes alkyl dimethylaminoacetic acid betaine, fatty acid aminopropyl betaine, and the like. The cationic surfactant includes mono (or di) long-chained alkyl quaternary ammonium salts and the like.

As the alkalizing agent, there can be formulated water-soluble inorganic salts such as carbonates, hydrogencarbonates and silicates; hardly water-soluble inorganic compounds such as crystalline silicates; and the like. Also, as other detergent components, there can be formulated water-soluble inorganic salts such as sulfates, sulfites, hydrogensulfates, hydrochlorides and phosphates; salts of water-soluble organic acids such as citrates and fumarates; hardly water-soluble inorganic compounds such as crystalline or amorphous aluminosilicates; and water-soluble polymers.

The water-soluble polymer includes carboxylate polymers, carboxymethyl cellulose, soluble starches, saccharides and the like. Among them, carboxylate polymers having a weight-average molecular weight of from several thousands to 100,000 are preferable, from the viewpoints of metal ion capturing ability, dispersibility of solid stains and particle stains and anti-redeposition property. Especially, salts of acrylic acid-maleic acid copolymers and polyacrylates are preferable. In addition, as the water-soluble salts, the above-mentioned alkalizing agents and those which can be used as the other detergent components can be used.

In addition, the base detergent particle encompasses the particles alone or a mixture of the above particles with other particles of salts as the other detergent component. For instance, when sodium bicarbonate (DENSE ASH) is mixed with the above-mentioned particle, the adhesive property of the surface modifier to the surface of sodium bicarbonate can be improved, so that there is an advantage that the anti-caking property, which is a benefit of the present invention, is improved.

The amount of the surfactant is preferably from 15 to 50% by weight of the base detergent particle. The upper limit of the amount of the surfactant is preferably 50% by weight or less, more preferably 40% by weight or less, and the lower limit of the amount is preferably 15% by weight or more, more preferably 20% by weight or more.

The amount of the alkalizing agent is preferably from 10 to 50% by weight of the base detergent particle. The lower limit of the amount of the alkalizing agent is preferably 10% by weight or more, more preferably 15% by weight or more, and the upper limit of the amount is preferably 50% by weight or less, more preferably 40% by weight or less.

Also, the amount of the other components is preferably from 20 to 60% by weight of the base detergent particle. The lower limit of the amount of the other components is preferably 20% by weight or more, more preferably 30% by weight or more, and the upper limit of the amount is preferably 60% by weight or less, more preferably 50% by weight or less.

It is preferable that the particle size of the base detergent particle is adjusted to 200 μm or more, preferably 250 μm or more, more preferably 270 μm or more, from the viewpoint of free flowability of the detergent, and that the particle size is adjusted to 550 μm or less, preferably 500 μm or less, more preferably 480 μm or less, from the viewpoint of avoiding losing dissolubility.

The binder usable in the present invention is preferably a liquid substance having a solidification property, a film forming property and a viscous behavior. Since the binder has the above characteristics, the dispersed fine powder for forming a base layer is firmly adhered to the surface of the base detergent particle, to stably form a base layer, so that rugged surfaces of the base detergent particle can be stably maintained.

Water and other components can be optionally contained in the binder during the preparation of the fine powder dispersion for forming a base layer, as long as the binder shows the characteristics as mentioned above after the base detergent particle is subjected to a surface treatment. For instance, even in a case where the viscosity is lowered because water is contained in the binder in order to provide easy handling of the fine powder dispersion for forming a base layer, the surface of the base detergent particle is highly modified when the binder has an adhesive property by transferring water in the fine powder dispersion for forming a base layer after the surface treatment of the base detergent particle to the base detergent particle by hydration of the water-soluble salt contained in the base detergent particle, or the like.

Examples of the binder include polyethylene glycol (meth)acrylic acid polymers, cellulose derivatives and aqueous solutions thereof. It is preferable that the polyethylene glycol has a weight-average molecular weight of 4000 to 50000, from the viewpoints of solidification and dissolubility after the surface treatment in the ordinarily operable temperature (about 40° C.) for the detergent. The lower limit of the weight-average molecular weight is preferably 4000 or more, more preferably 6000 or more, and the upper limit is preferably 50000 or less, more preferably 30000 or less, still more preferably 15000 or less. The cellulose derivatives include carboxymethyl cellulose (CMC), methyl cellulose, hydroxypropyl methyl cellulose, and the like. Among these binders, a melting solution of the polyethylene glycol having a weight-average molecular weight of 4000 or more and 20000 or less, and an aqueous solution thereof is especially preferable. In addition, these binders may be used alone or in admixture of two or more kinds.

As the fine powder for forming a base layer dispersed in the above-mentioned binder, those having an average particle size of 0.1 to 5 μm are preferably used. The lower limit of the average particle size is preferably 0.1 μm or more, more preferably 0.2 μm or more, from the viewpoint of forming rugged surface by the base layer on the surface of the base detergent particle. On the other hand, its upper limit is preferably 5 μm or less, more preferably 3 μm or less, still more preferably 2 μm or less, especially preferably 1 μm or less, most preferably 0.8 μm or less, from the viewpoint of the non-stripping property of the formed base layer.

As the fine powder for forming a base layer, there can be used powders used for a general surface modifier as described in Technical Publication Tokkyocho Koho 10(1998)-25[7159]: Shuchi and Kanyo Gijutsu Shu (Clothes Powder Detergent: Japanese Patent Office, published on Mar. 26, 1998). For instance, there can preferably be used crystalline or amorphous aluminosilicates, calcium silicates, silicon dioxide, clay minerals, talc, layered compounds, amorphous silica derivatives, crystalline silicate compounds, metallic soaps and the like. The crystalline aluminosilicates (zeolites) having an ability of capturing water hardness-increasing components are preferable, from the viewpoint of detergency.

In addition, when the fine powder is required to be efficiently and rapidly pulverized to a desired particle size, it is preferable that a clay mineral be used for a part or all of the fine powder, and especially a layered clay mineral is preferable. As the layered clay mineral, the three representative examples are kaolin mineral, mica clay mineral and smectite (montmorllonite). Among the layered clay minerals, bentonite, which is a swellable clay mineral, which increases its volume by water absorption and comprises montmorillonite as its main component, is most preferable. Although there are no problems even when the layered clay mineral is used in a solution not containing water, the layered clay mineral has a property that the layered clay mineral swells especially when used in water so that the layer is easily stripped off, thereby resulting in further improvement in pulverizability. Therefore, it is preferable to use the layered clay mineral in a solution containing water.

These fine powders for forming a base layer can be used alone or in admixture of two or more kinds.

As the fine powder for forming a base layer, there can also be used other powder components such as pigment components and fluorescers as desired besides the above-mentioned fine powder. For instance, a hardly water soluble, dimorpholino-type fluorescer, which is the component of which formulation has been difficult in conventional preparation processes, can be easily added by dispersing the dimorpholino-type fluorescer and spraying the dispersion to the base detergent particle without having to formulate the dimorpholino-type fluorescer in the spray-drying slurry.

The fine powder for forming a base layer is obtained by a build-up method in which a fine powder of a desired particle size is previously prepared by a known vapor-phase synthesis method, liquid-phase synthesis method, or the like; or a break-down method in which a known powder particle is pulverized to a fine powder of a desired particle size. The build-up method is a technique of controlling the particle size by controlling the reaction rate or the condensation rate. However, since the build-up method requires high-level control and is costly, the break-down method is preferred with the exception of a special case where a high purity is necessary.

In the break-down method, there are dry pulverization and wet pulverization methods. In dry pulverization, a pulverizer such as a ball-mill or a hammer-mill is suitable, and in wet pulverization, a pulverizer such as a line-mill or media mill is suitable. Wet pulverization is more preferable, from the viewpoints of the desired particle size and pulverization efficiency.

The fine powder dispersion for forming a base layer usable in the present invention is one in which a fine powder for forming a base layer is dispersed in the above-mentioned binder. In the present invention, since the fine powder dispersion for forming a base layer is used, there are some advantages that the fine powder for forming a base layer can be efficiently adhered to the surface of the base detergent particle without aggregating the fine powder, so that rugged surfaces can be more efficiently formed on the surface of the base detergent particle. Also, it is preferable that the fine powder for forming a base layer is more uniformly dispersed from the viewpoint of increasing the treatment efficiency of the surface of the base detergent particle. Accordingly, the present invention is concerned with the fine powder dispersion for forming a base layer.

The fine powder dispersion for forming a base layer can be obtained by uniformly dispersing a particle used as a raw material for the fine powder for forming a base layer in a binder, and subjecting the dispersion to wet pulverization to a desired particle size. Preferred wet-type pulverizers include media mill-type pulverizers, represented by T. K. Homomic Line Mill (trade name) commercially available from Tokushu Kika Kogyo KK. and DYNO-Mill (trade name) commercially available from Willy A. Bachofen AG Maschinenfabrik, Switzerland). The media-type mill pulverizers are especially preferable because of their high pulverization efficiency.

When a high load is applied to the media mill due to the viscosity of the binder, the treatment may be carried out with the media mill for two or more times. Alternatively, the treatment may be carried out by previously uniformly dispersing the particle from which the fine powder is originated in water or a low-viscosity liquid such as a binder having a lower viscosity, and subjecting the dispersion to wet-type pulverization by using a preferable pulverizer such as a media mill so that the resulting fine powder is dispersed in the binder in a given amount. In this case, the amount of the low-viscosity liquid must be adjusted in order not to impair its film-producing ability of the binder.

It is preferable that the treatment is carried out with the pulverizer for two or more times from the viewpoints that the particle size distribution of the fine powder for forming a base layer is made sharper and the base layer can be more stably formed.

In the case of the above-mentioned wet-type pulverization, water is contained in an amount of preferably at least 1 part by weight, more preferably 5 parts by weight or more, still more preferably 10 parts by weight or more, based on 100 parts by weight of the fine powder dispersion for forming a base layer.

The weight ratio of the fine powder for forming a base layer to the binder in the fine powder dispersion for forming a base layer is preferably from 1/40 or more and 1/10 or less, more preferably from 1/35 or more and 1/15 or less, from the viewpoints of formability of fine rugged surfaces of the base detergent particle sufficient for obtaining the effects of the present invention, and easy handling due to the viscosity of the fine powder dispersion for forming a base layer.

In addition, it is preferable that the fine powder dispersion for forming a base layer is added in an amount of from 0.5 to 5 parts by weight, based on 100 parts by weight of the base detergent particle. The lower limit of the amount is preferably 0.5 parts by weight or more, more preferably 1 part by weight or more, based on 100 parts by weight of the base detergent particle in order to sufficiently carry out the surface treatment of the base detergent particle. The upper limit of the amount is preferably 5 parts by weight or less, more preferably 4 parts by weight or less, based on 100 parts by weight of the base detergent particle from the viewpoint of avoiding losing dissolubility due to coating of the binder component.

The surface modifier used in the present invention has a primary average particle size of preferably 10 μm or less, more preferably 0.1 μm or more and 10 μm or less. When the average particle size is 10 μm or less, the adhesive property of the surface modifier to the surface of the base detergent particle having a base layer formed is improved. The average particle size of the surface modifier can be measured by a method utilizing light scattering by, for instance, a particle analyzer (commercially available from Horiba, LTD.), or it may be measured by a microscopic observation or the like. In addition, it is preferable that the surface modifier has a high ion exchange capacity or a high alkalizing ability from the aspect of detergency. As the surface modifier, an aluminosilicate, which may be crystalline or amorphous, is desirable. Besides the aluminosilicate, also preferable are fine powders of sodium sulfate, calcium silicates, silicon dioxide, bentonite, talc, clay, amorphous silica derivatives, or silicate compounds such as crystalline silicate compounds. In addition, there can also similarly be used a metal soap having a primary particle size of 0.1 μm or more and 10 μm or less, a powdery surfactant (for instance, an alkyl sulfate, or the like), or a water-soluble organic salt. When the crystalline silicate compound is used, it is preferably used in admixture of fine powder other than the crystalline silicate compound for the purpose of preventing deterioration owing to aggregation of the crystalline silicates by moisture absorption and carbon dioxide absorption, and the like.

The process for preparing the detergent particle of the present invention comprises the steps of treating a surface of a base detergent particle with a fine powder dispersion, comprising a binder as a dispersion medium, thereby forming a base layer comprising a fine powder on the surface of the base detergent particle, and then coating the surface of the base layer with a surface modifier.

The detergent particle of the present invention obtained by the above-mentioned process has a markedly improved anti-caking property, and excellent dissolubility and adhesive property.

In addition, the detergent particle of the present invention can be also used as a detergent composition in admixture with a known detergent base material such as a surfactant and a builder, a bleaching agent (percarbonates, perborates, bleaching activators, and the like), an anti-redeposition agent (carboxymethyl cellulose, and the like), a softening agent, a reducing agent (sulfites, and the like), a fluorescent whitener, a defoaming agent (silicone, and the like), an enzyme such as cellulase or protease, a perfume and the like.

The detergent composition comprising the detergent particle of the present invention can be applied to various applications. For instance, the detergent composition can be used as laundry detergents, laundry bleaching agents, cleaning agents for hard surface such as detergents for automatic dishwashers, pipe cleaners, and the like.

### EXAMPLES 1 TO 10 AND COMPARATIVE EXAMPLES 1 TO 3

First, a base detergent particle was prepared by the process described below.

A mixing vessel equipped with a jacket was charged with 407 parts by weight of water, and hot water at 40° C. was allowed to flow through the jacket. Thereto were sequentially added 132 parts by weight of sodium carbonate (DENSE ASH (average particle size: 290 μm), commercially available from Central Glass Co., Ltd.), 132 parts by weight of sodium sulfate (neutral anhydrous sodium sulfate (average particle size: 240 μm), commercially available from Shikoku Kasei K.K.), 5 parts by weight of sodium sulfite (sodium sulfite (average particle size: 90 μm), commercially available from Mitsui Toatsu K.K.), 72 parts by weight of a 40% by weight-aqueous sodium polyacrylate (average molecular weight: 10000, commercially available from Kao Corporation), 1 part by weight of a fluorescent dye (trade name: Tinopal CBS-X, commercially available from Ciba Geigy AG), and 252 parts by weight of a zeolite (commercially available from Zeobuilder, 4A-type, average particle size: 3.5 μm, commercially available from Tosoh Corporation), and the resulting mixture was stirred for 15 minutes, to give a homogeneous pre-slurry at 40° C.

Next, the temperature of the pre-slurry was adjusted to 60° C. by agitating the pre-slurry for 30 minutes, with allowing hot water at 60° C. to flow through the jacket, to give a working slurry. The resulting working slurry was fed to a spray-drying tower (countercurrent flow type) with a pump, and sprayed from a pressure-spray nozzle attached near the top of the tower at a spraying-pressure of 2.5 MPa. The high-temperature gas to be fed to the spray-drying tower was fed at a temperature of 210° C. from the bottom of the tower, and exhausted at 105° C. from the top of the tower. The water content of the resulting spray-dried particles was 4% by weight.

A base detergent particle was prepared by using the resulting spray-dried particles according to the method described below.

A surfactant composition (polyoxyethylene alkyl ether/polyethylene glycol/sodium dodecylbenzenesulfonate/water=21/4/21/4 (weight ratio)) was adjusted to 80° C. Next, 100 parts by weight of the spray-dried particles were supplied into a Lödige Mixer (commercially available from Matsuzaka Giken Co., Ltd.; capacity: 130 L; equipped with a jacket), and the agitation of the main shaft (rotational speed: 60 rpm; peripheral speed: 1.6 m/s) was started. Incidentally, hot water at 80° C. was allowed to flow through the jacket at 10 L/minute. Fifty parts by weight of the above surfactant composition were supplied into the above mixer for 2 minutes, and thereafter the resulting mixture was agitated for 5 minutes, to give a base detergent particle.

Here, as the polyoxyethylene alkyl ether, “EMULGEN 108 KM” commercially available from Kao Corporation (trade name, average moles of ethylene oxides: 8.5; number of carbon atoms in alkyl moiety: 12 to 14) was used. As the polyethylene glycol, “K-PEG 6000” commercially available from Kao Corporation (trade name, average molecular weight: 8500) was used.

Next, the powder dispersion for forming a base layer was prepared according to the method described below.

Three or five parts by weight of a fine powder zeolite (commercially available from Zeobuilder, average particle size: 3.5 μm) was added to 100 parts by weight of an aqueous solution of a polyethylene glycol binder (average molecular weight: 13000) having a purity of 60% by weight. The resulting mixture was subjected to wet pulverization using a DYNO-Mill, Model KD-45 (trade name, commercially available from Willy A. Bachofen AG Maschinenfabrik, Switzerland), to give a powder dispersion for forming a base layer. The media used in the DYNO-Mill were YTZ zirconia beads having a diameter of 0.5 mm (trade name, commercially available from NIKKATO CORPORATION), the packing ratio was 85%, and the peripheral speed of the pulverization impellers was 16 m/s. The average particle size of the zeolite after pulverization was measured by using a device LA-920 (trade name, commercially available from Horiba, LTD.). A zeolite having a final particle size of 0.5 to 3 μm (Examples 1 to 6) was obtained by controlling the amount of the solution to be treated in the DYNO-Mill, specifically the flow rate of the solution fed to the DYNO-Mill and the number of rotations of the agitator. Also, the same procedures were carried out, except for using as binders a sodium salt of CMC having a purity of 1% by weight (commercially available from Nippon Paper Industries Co., Ltd., trade name: F20LC, etherification degree: 0.6) and a sodium acrylate homopolymer having a purity of 40% by weight (commercially available from TOAGOSEI CO., LTD., trade name: HM-10, average molecular weight: 6000), to give a powder dispersion for forming a base layer (Examples 7 and 8). Incidentally, the average particle size of the powder (zeolite) was adjusted to 0.5 μm.

Similarly, 5 parts by weight of a fine powder bentonite (trade name: FULASOFT-1, commercially available from SUD-CHEMIE PERU S. A.) was added as a binder to 100 parts by weight of an aqueous solution of polyethylene glycol (average molecular weight: 13000) having a purity of 60% by weight. The resulting mixture was subjected to wet pulverization by using a DYNO-Mill, Model KD-45, to give a powder dispersion for forming a base layer (Examples 9 to 11). Incidentally, the average particle size of the powder (bentonite) was adjusted to 0.3 to 0.9 μm.

Also, in Example 6, in addition to the above-mentioned aqueous solution of polyethylene glycol and the zeolite, a dimorpholino-type (stilbene-type) fluorescer (commercially available from Makhteshim, trade name: BRY-10) or sodium carbonate was added, to give a powder dispersion for forming a base layer.

Also, in Example 1, the above-mentioned dispersion comprising polyethylene glycol and zeolite was subjected to high-dispersion by passing through a T. K. homomic line mill, Model: S (trade name, commercially available from Tokushu Kika Kogyo Co. Ltd.) at a rotational speed of 3600 rpm with a clearance of 0.4 mm, to give a zeolite dispersion of which zeolite having a final average particle size of 3 μm. Incidentally, the final liquid temperature was adjusted to about 80° C. by controlling the temperatures of the DYNO-Mill and the jacket of the line mixer.

The powder dispersion for forming a base layer having temperature-adjusted to 80° C. was sprayed to the above-mentioned base detergent particle thus obtained, while agitating using the above-mentioned Lödige Mixer, thereby surface-treating the base detergent particle. Incidentally, hot water at 80° C. was allowed to flow through the jacket of the Lödige Mixer at 10 L/minute.

Next, surface modification was carried out by adding zeolite (commercially available from Zeobuilder, 4A-type, average particle size: 3.5 μm) to the surface-treated base detergent particle, and agitating the resulting mixture using a Lodige Mixer, to give a detergent particle.

Thereafter, the resulting detergent particle was blended with an enzyme (commercially available from Novozymes, trade name: Kannase 24T) and a perfume using a rotary kiln, to give a final detergent composition.

Similarly, comparative detergent compositions were prepared as follows. The detergent particle of Comparative Example 1 was prepared without spraying a powder dispersion for forming a base layer, and the detergent particles of Comparative Examples 2 and 3 were prepared by spraying only an aqueous solution of a binder (polyethylene glycol (average molecular weight: 13000) having a purity of 60% by weight) to the base detergent particle, without adding fine powder for forming a base layer.

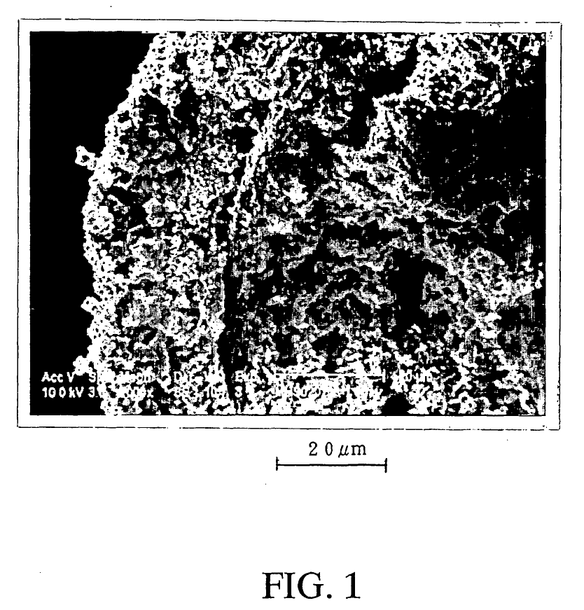

The split cross sections of the final detergent compositions obtained in Examples 1 to 11 were observed by an SEM. As a result, as seen in FIG. 1, it was confirmed that fine particles were present on the base detergent particle and a surface modifier zeolite was further present thereon as an outer layer.

As the properties of the detergent composition thus prepared, the anti-caking property, the dissolution ratio, and the adhesive property of the surface modifier were determined by the test methods described below. The results are shown in Tables 1, 2, and 3.

The test for anti-caking property was carried out by the accelerated test as described below.

A box-shaped container having dimensions of 145 mm in length, 90 mm in width, and 57 mm in height was made from a cardboard having a water vapor transmission rate, as determined according to JIS Z 0208, of from 20 to 30 g/m² in 24 hours. Next, 300 g of the detergent composition obtained by the above-mentioned preparation method was filled in the container. Thereafter, the above container was maintained in a thermostat kept at a temperature of 30° C. and at a relative humidity of 70% for 168 hours, and the sieve permeability was determined. The sieve permeability was obtained as follows. The detergent composition stored in the box-shaped container was gently transferred to a mesh having a sieve opening of 5 mm, and a solidified portion was separated from an unsolidified portion by sieving. The weight of each portion was determined, and the sieve permeability was calculated by the following equation (1).
Sieve Permeability (%)=[P/(O+P)]×100 (1)
wherein P: Weight (g) of the sieve-pass detergent after sieving.
O: Weight (g) of the sieve-on detergent after sieving.

The effect of improvement in the anti-caking property was calculated by the equation (2) based on the sieve permeability of the detergent composition prepared without adding a powder dispersion for forming a base layer and a binder.
Effect of Improvement in Anti-caking Property (%)=(S−R)/R×100 (2)
R: Sieve permeability of a detergent composition prepared without adding a powder dispersion for forming a base layer and a binder (Comparative Example 1)
S: Sieve permeability of a detergent composition prepared by adding a powder dispersion for forming a base layer and/or a binder

The test for dissolubility was carried out by the following method.

When a detergent composition was supplied into water at 5° C., agitated for 60 seconds under the agitation conditions given below, and passed through a standard sieve according to JIS Z8801 (sieve opening: 37 μm), the dissolution ratio was expressed by a value calculated by equation (3):
Dissolution Ratio (%)={1−(T/S)}×100 (3)
S: Weight (g) of a detergent composition supplied
T: Dry weight (g) of insoluble remnants of the detergent composition remaining on the sieve when the aqueous solution obtained under the above-mentioned agitation conditions was passed through the above-mentioned sieve (drying conditions: maintaining at a temperature of 105° C. for 1 hour, and thereafter maintaining in a desiccator (25° C.) containing silica gel for 30 minutes).

Agitation Conditions: One gram of a detergent composition was supplied into 1 liter of hard water (71.2 mg CaCO/iter, molar ratio of Ca/Mg=7/3), and agitated with an agitation bar (length: 35 mm, diameter: 8 mm) in a 1-liter beaker (inner diameter: 105 mm). The rotational speed was 800 rpm.

The adhesion of a surface modifier zeolite was determined by measuring the amount of the surface modifier zeolite with a Fourier transform infrared spectrophotometer (commercially available from Shimadzu Corporation, trade name: FTIR 8400) and photoacoustic spectroscopy (commercially available from MTEC photoacoustic, trade name: PAS Model 300) under the following determination conditions. In the photoacoustic spectroscopy, the information in the direction of depth from the surface of a sample can be obtained, so that the composition near the surface of the sample can be estimated. Specifically, the adhesion of the surface modifier can be estimated by calculating the ratio of the absorption peak ascribed to the components of the base detergent particle to the absorption peak ascribed to the surface modifier. In this Example, the peak intensity (A) at 1581.6 cm⁻¹ from the acrylate polymer contained in the base detergent particle, and the peak intensity (Z) at 1658.8 cm⁻¹ from the surface modifier zeolite were determined, and the adhesion of the surface modifier zeolite was estimated according to the ratio of Z to A. Here, the larger the obtained ratio of Z to A, the more excellent the adhesion of zeolite.

<Determination Conditions>

Scan rate: 128
Moving Mirror Speed 2.8
Resolution 8 cm⁻¹

Apodization Function Happ

TABLE 1

| | Comp. | Comp. | Comp. | | | | |
|---|---|---|---|---|---|---|---|
| | Ex. 1 | Ex. 2 | Ex. 3 | Ex. 1 | Ex. 2 | Ex. 3 | Ex. 4 |
| Composition of | | | | | | | |
| Detergent Composition | | | | | | | |
| Base Detergent Particle | 87.80 | 86.80 | 83.30 | 86.75 | 86.75 | 86.75 | 86.72 |
| (% by weight) | | | | | | | |
| Binder (% by weight) | — | 1.00 | 3.50 | — | — | — | — |
| Fine Powder Dispersion | — | — | — | 1.05 | 1.05 | 1.05 | 1.08 |
| for Forming Base Layer | | | | | | | |
| (% by weight) | | | | | | | |
| Surface Modifier Zeolite | 11.00 | 11.00 | 11.00 | 11.00 | 11.00 | 11.00 | 11.00 |
| (% by weight) | | | | | | | |
| Enzyme (% by weight) | 1.00 | 1.00 | 1.00 | 1.00 | 1.00 | 1.00 | 1.00 |
| Perfume (% by weight) | 0.20 | 0.20 | 0.20 | 0.20 | 0.20 | 0.20 | 0.20 |
| Composition of Fine | | | | | | | |
| Powder Dispersion for | | | | | | | |
| Forming Base Laver | | | | | | | |
| Binder (parts by wt.) | — | 100 | 100 | 100 | 100 | 100 | 100 |
| Kind of Binder | — | PEG | PEG | PEG | PEG | PEG | PEG |
| | | (60% Aq. | (60% Aq. | (60% Aq. | (60% Aq. | (60% Aq. | (60% Aq. |
| | | Soln.) | Soln.) | Soln.) | Soln.) | Soln.) | Soln.) |
| Fine Powder Zeolite | — | — | — | 5 | 3 | 5 | 5 |
| (parts by weight) | | | | | | | |
| Particle Size of Zeolite (μm) | — | — | — | 3 | 0.5 | 0.5 | 0.9 |
| Properties | | | | | | | |
| Effect of Improvement in | Standard | 1.3 | 31.2 | 16.7 | 16.5 | 41.5 | 26.3 |
| Anti-Caking Property (%) | | | | | | | |
| Dissolution Ratio (%) | 83 | 83 | 69 | 87 | 84 | 86 | 86 |
| Adhesive Property (−) | 1.565 | 1.637 | 1.711 | 1.658 | 1.728 | 1.729 | 1.753 |

Note:
PEG (60% Aq. Soln.): Polyethylene glycol (60% aqueous solution)

TABLE 2

| | Ex. 5 | Ex. 6 | Ex. 7 | Ex. 8 |
|---|---|---|---|---|
| Composition of | | | | |
| Detergent Composition | | | | |
| Base Detergent Particle | 86.75 | 86.75 | 86.75 | 86.75 |
| (% by weight) | | | | |
| Fine Powder Dispersion for | 1.05 | 1.05 | 1.05 | 1.05 |
| Forming Base Layer | | | | |
| (% by weight) | | | | |
| Surface Modifier Zeolite | 11.00 | 11.00 | 11.00 | 11.00 |
| (% by weight) | | | | |
| Enzyme (% by weight) | 1.00 | 1.00 | 1.00 | 1.00 |
| Perfume (% by weight) | 0.20 | 0.20 | 0.20 | 0.20 |
| Composition of Fine | | | | |
| Powder Dispersion for | | | | |
| Forming Base Layer | | | | |
| Polymer | 100 | 100 | 100 | 100 |
| (parts by weight) | | | | |
| Kind of Binder | PEG | PEG | CMC | Sodium |
| | (60% | (60% | (1% | Acrylate |
| | Aq. | Aq. | Aq. | Homo- |
| | Soln.) | Soln.) | Soln.) | polymer |
| | | | | (40% |
| | | | | Aq. |
| | | | | Soln.) |
| Fine Powder Zeolite | 5 | 5 | 5 | 5 |
| (parts by weight) | | | | |
| Sodium Carbonate | 2 | — | — | — |
| (parts by weight) | | | | |
| Dimorpholino-type | — | 9.5 | — | — |
| Fluorescer | | | | |
| (parts by weight) | | | | |
| Particle Size of Zeolite | 0.5 | 0.5 | 0.5 | 0.5 |
| (μm) | | | | |
| Properties | | | | |
| Effect of Improvement in | 38.7 | 40.2 | 19.0 | 14.4 |
| Anti-Caking Property | | | | |
| (%) | | | | |
| Dissolution Ratio (%) | 86 | 85 | 81 | 86 |
| Adhesive Property (−) | 1.738 | 1.733 | 1.772 | 1.701 |

Note:
PEG (60% Aq. Soln.): Polyethylene glycol (60% aqueous solution)
CMC (1% Aq. Soln.): Carboxymethyl cellulose (1% aqueous solution)
40% Aq. Soln.: 40% aqueous solution

TABLE 3

| | Ex. 9 | Ex. 10 | Ex. 11 |
|---|---|---|---|
| Composition of | | | |
| Detergent Composition | | | |
| Base Detergent Particle | 86.75 | 86.75 | 86.75 |
| (% by weight) | | | |
| Fine Powder Dispersion for | 1.05 | 1.05 | 1.05 |
| Forming Base Layer | | | |
| (% by weight) | | | |
| Surface Modifier Zeolite | 11.0 | 11.0 | 11.0 |
| (% by weight) | | | |
| Enzyme (% by weight) | 1.00 | 1.00 | 1.00 |
| Perfume (% by weight) | 0.20 | 0.20 | 0.20 |
| Composition of Powder | | | |
| Dispersion for | | | |
| Forming Base Layer | | | |
| Polymer | 100 | 100 | 100 |
| (parts by weight) | | | |
| Kind of Binder | PEG (60% | PEG (60% | PEG (60% |
| | Aq. Soln.) | Aq. Soln.) | Aq. Soln.) |
| Fine Powder Bentonite | 5 | 5 | 5 |
| (parts by weight) | | | |
| Particle Size of | 0.3 | 0.5 | 0.9 |
| Bentonite (μm) | | | |
| Properties | | | |
| Effect of Improvement in | 42.1 | 39.9 | 30.1 |
| Anti-Caking Property (%) | | | |
| Dissolution Ratio (%) | 85 | 84 | 86 |
| Adhesive Property (−) | 1.761 | 1.742 | 1.733 |

Note:
PEG (60% Aq. Soln.): Polyethylene glycol (60% aqueous solution)

It can be seen from the results in Tables 1 and 2 that all of the detergent compositions formulated with the fine powder zeolite obtained in Examples 1 to 8 have a markedly improved anti-caking property and excellent dissolubility and adhesion of the surface modifier, as compared to those of Comparative Examples 1 to 3. Incidentally, it can be seen from the results of Comparative Example 3 that the dissolution ratio is markedly decreased when a large amount of a binder is used even though the anti-caking property is somewhat improved.

It can be seen from the results in Table 3 that the detergent compositions formulated with the fine powder bentonite obtained in Examples 9 to 11 have a markedly improved anti-caking property, excellent dissolubility and adhesion of the surface modifier, as compared to those of Comparative Examples 1 to 3.

### INDUSTRIAL APPLICABILITY

The detergent composition of the present invention has an excellent storage stability without lowering the dissolubility. The detergent composition comprising the detergent particle of the present invention can be applied to laundry detergents, laundry bleaching agents, cleaning agents for hard surface such as detergents for automatic dishwashers, pipe cleaners, and the like.

1. A detergent particle comprising:
a base detergent particle,
a base layer comprising a fine powder for forming a base layer, prepared by treating a surface of the base detergent particle with a fine powder dispersion, wherein the fine powder is dispersed in a binder, wherein said base layer is formed on a surface of the base detergent particle, and
a surface coating comprising a surface modifier, which is formed on the base layer.

2. The detergent particle according to claim 1, wherein an average particle size of the fine powder is 0.1 μm or more and 5 μm or less.

3. The detergent particle according to claim 1, wherein an amount of the fine powder dispersion is from 0.5 to 5 parts by weight, based on 100 parts by weight of the base detergent particle.

4. The detergent particle according to claim 1, wherein a weight ratio of the fine powder to the binder in the fine powder dispersion is 1/40 or more and 1/10 or less.

5. The detergent particle according to claim 1, wherein the binder is at least one member selected from the group consisting of polyethylene glycol, (meth)acrylic polymers, cellulose derivatives, aqueous solutions thereof.

6. The detergent particle according to claim 1, wherein the binder comprises a melting solution and/or aqueous solution of polyethylene glycol having a weight-average molecular weight of 4000 or more and 50000 or less.

7. The detergent particle according to claim 1, wherein the fine powder for forming a base layer is at least one member selected from the group consisting of crystalline or amorphous aluminosilicates, calcium silicates, silicon dioxide, bentonite, talc, clay, amorphous silica derivatives, crystalline silicate compounds, metal soaps, and mixtures thereof.

8. The detergent particle according to claim 1, wherein the base detergent particle comprises a particle a spray-dried particle comprising substantially no surfactants with a surfactant mixed solution comprising one or more surfactants to support the surfactant mixed solution.

9. A process for preparing a detergent particle, comprising the steps of:
treating a surface of a base detergent particle with a fine powder dispersion, thereby forming a base layer on the surface of the detergent particle, wherein the fine powder dispersion comprises a fine powder dispersed in a binder, and
surface-coating the base layer with a surface modifier.

10. A fine powder dispersion for forming a base layer comprising a binder and a fine powder, wherein the fine powder is dispersed in the binder.

11. The detergent particle according to claim 1, wherein the fine powder dispersion further comprises a layered clay mineral and water.

12. The detergent particle according to claim 11, containing water in an amount of at least 1 part by weight based on 100 parts by weight of the fine powder dispersion.

13. A detergent particle comprising:
a) a base detergent particle,
b) a base layer formed on the surface of the base detergent particle, wherein the base layer comprises a fine powder and a binder, and
c) a surface modifier coated on the base layer.
